(19) United States
(12) Patent Application Publication
(10) Pub. No.: US 2018/0250533 A1
(43) Pub. Date: Sep. 6, 2018

(54) Vehicle Seatbelt with Spring-loaded Window Breaker

(71) Applicant: Andrew Petersen, Palm Harbor, FL (US)

(72) Inventor: Andrew Petersen, Palm Harbor, FL (US)

(21) Appl. No.: 15/448,839

(22) Filed: Mar. 3, 2017

(51) Int. Cl. A62B 3/00; A44B 11/25; B60R 22/32; A44B 11/00

(52) U.S. Cl. CPC A62B 3/005; A44B 11/005; B60R 22/32; A44B 11/2503

(57) ABSTRACT

A window breaking system has a seatbelt buckle interfaced to a vehicle through a seatbelt and a seatbelt receiver interfaced to the vehicle for removably receiving the seatbelt buckle. A window breaking mechanism is integrated to the seatbelt buckle such that, in the event escape from the vehicle is needed, the seatbelt buckle is released from the seatbelt receiver and the window breaking mechanism is used to break a window, through which the user (occupant) is now able to escape.

### FIELD

This invention relates to the automotive field and more particularly to a system for passenger safety after an accident.

### BACKGROUND

Vehicular accidents often leave the electrical system disabled or the door/window mechanism damaged, thereby preventing escape from a vehicle through a window. This lack of escape is especially dangerous when the vehicle ends up in a body of water or afire. Automobile glass is difficult to break. Being such, many people have died having been trapped within a vehicle, unable to provide sufficient leverage and/or strength as to break one of the windows and escape.

Window breakers are well known in the art as evidenced, for example, by U.S. Pat. No. 8,740,030 to Purdy, et. Al. which describes a window-mounted window breaker that has a spring-loaded plunger. This device is intended to be mounted on a window, for example, a bus window.

Another example is U.S. Pat. Pub. No. 2013/0146381 to Oosterhuis et al., shows an electronic window breaker that is integrated into a vehicle. Such relies on the electrical system being operational after an accident. Additionally, such is too easy to activate and may be inadvertently activated by, for example, a child.

Another example is U.S. Pat. Pub. No. 2009/0265858 to White describes a hand-held window breaking device. Such devices are good for carrying by first responders, but after an accident has occurred, finding such device within a vehicle is often difficult. The glove compartment may be inaccessible, if left in a cup holder, this device may migrate to a distant location in the vehicle after impact, if in water, this device may be difficult to see and find, etc.

Finally, in another example, U.S. Pat. Pub. No 2013/0167601 to Colasse describes a spring-loaded window breaker integrated into a vehicle key. This disclosure exemplifies the need to have the window breaker in a convenient, easy-to-find location so it is accessible immediately after an accident. This publication is hereby incorporated by reference to show an exemplary, spring-loaded window breaking mechanism. As vehicles are transitioning to “keyless” ignitions, vehicle keys (key fobs) will find themselves in pockets or at the bottom of purses and, therefore, may be difficult to access or may be thrown around the passenger compartment during an accident. In addition, this device is only useful in circumstances where the driver is conscious and able to remove the key (and window breaker) from the ignition and break a window. Damage to the steering column may prevent removal. This device does not offer a window breaker to other occupants of the vehicle that may not be able to reach the ignition area. The added weight of the window breaker to the key makes the key heavy and bulky, making it undesirable to carry on a day-to-day basis. Further, there have been past issues related to vehicle ignition systems when too much weight was added to a key (e.g. by ornamental objects or other keys attached to a keyring). Therefore, adaption of the device described in this publication will likely be minimal making it less effective at saving lives.

What is needed is a system that will be readily available to at least one occupant of a vehicle to break a window in an emergency.

### SUMMARY

In many countries and for most vehicles, by law, it is required to have seat belts for every passenger. The present invention integrates a window breaking mechanism with a seatbelt buckle making the window breaking mechanism readily available should an accident occur. By integrating the window breaking mechanism with the seatbelt buckle, it will be easy to find during the panic of the accident, and it will be tethered to the seatbelt, so as to not lose it if it slips out of one's hand.

In one embodiment, a window breaking system is disclosed including a seatbelt buckle interfaced to a vehicle through a seatbelt and a seatbelt receiver interfaced to the vehicle. A window breaker is integrated to the seatbelt buckle such that, in the event escape from the vehicle is needed, the seatbelt buckle is released from the seatbelt receiver and the window breaker is used to break a window, through which the user (occupant) is now able to escape.

In another embodiment, a method of exiting a vehicle is disclosed including disengaging a seatbelt buckle from a seatbelt receiver. The seatbelt buckle has an integrated window breaker. A movable portion of the integrated window breaker is then pushed against a window until and therefore, a glass-breaking spike of the integrated window breaker is hurled at the window. Now that the window is broken, the user exits through an opening vacated by the window.

In another embodiment, an apparatus for window breaking includes a seatbelt buckle with a window breaker integrated to the seatbelt buckle.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a sectional view of a window breaker integrated into a seatbelt buckle.

FIG. 2 illustrates an elevational view of the window breaker integrated into the seatbelt buckle showing a seat belt threaded therethrough.

FIG. 3 illustrates a perspective view of the window breaker integrated into the seatbelt buckle showing the window breaker and seatbelt buckle disengaged from the seatbelt buckle receiver and being used to break a window.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

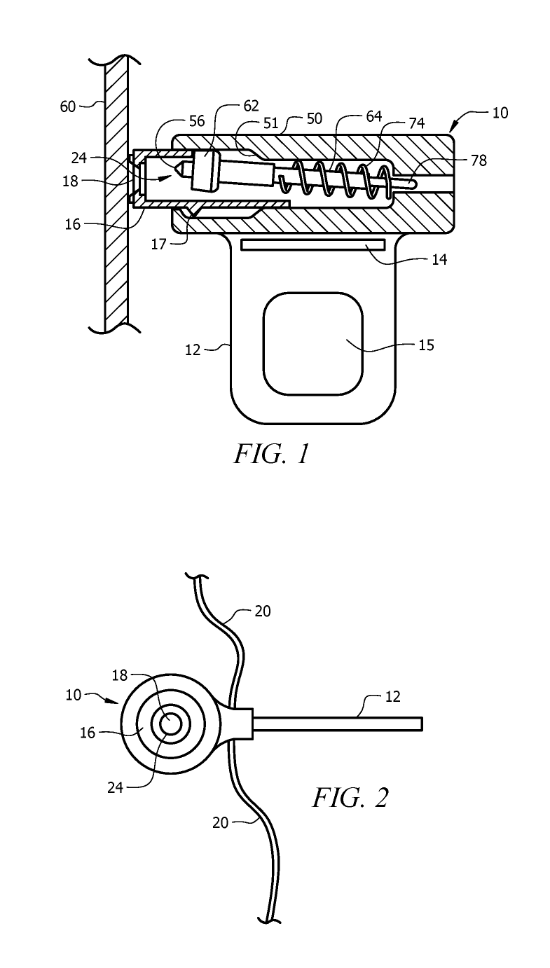

Referring to FIG. 1, a sectional view of a window breaker integrated into a seatbelt buckle 10 is shown. Although any known or future glass breaking device is anticipated, an exemplary window breaking mechanism 24 is shown integrated into the seatbelt buckle 12. This exemplary window breaking mechanism 24 is contained within a housing 50 that is molded to, affixed, or otherwise integrated into the seatbelt buckle 12. The exemplary window breaking mechanism 24 has a movable portion 16 that telescopedly moves in/out of the housing 50. Within the movable portion 16 is a glass-breaking spike 56 that, when not in use, is retained within the movable portion 16 so as to not catch on the occupant's clothing, etc. As the movable portion 16 is pressed against the window 60, the movable portion telescopes into the housing 50, pushing the mass portion 62 attached to the glass breaking spike 56 along an upper edge of the inside of the housing 50, thereby loading a spring that is mounted around a base 64 of the glass breaking spike 56. A tail 78 of the glass breaking spike 56 moves within a rear-bore of the housing 50. Once the movable portion 16 is pushed far enough into the housing 50, the mass portion 62 hits the ramp 51, is freed from the movable portion 16 and the movable portion 16 and glass breaking spike 56 are hurled by the force of the spring 74 toward a aperture 18 in the movable portion 16. The glass breaking spike 56 is pushed out of the aperture 18 far enough to hit the window 60 with enough force as to break the window 60. Again, this is an exemplary spring-loaded glass breaker, as any type of glass breaking mechanism is anticipated to be integrated with the seatbelt buckle 12.

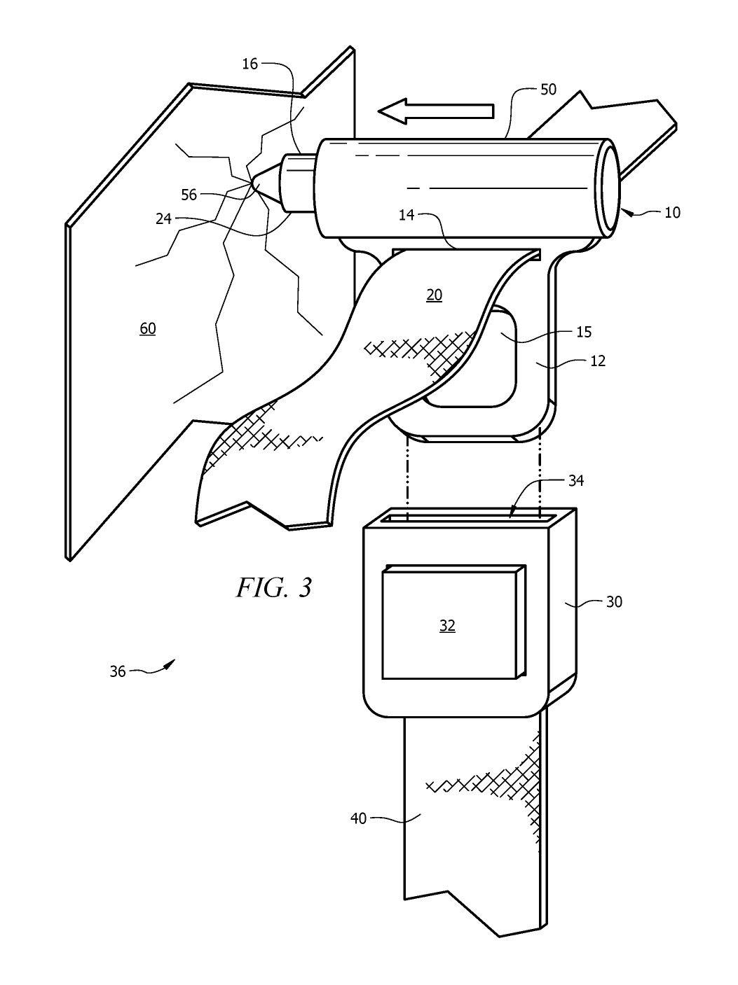

The window breaking mechanism 24 is molded to, affixed, or otherwise integrated into the seatbelt buckle 12. The seatbelt buckle 12 has a slot for accepting a seatbelt 20 (see FIGS. 2 and 3). The seatbelt buckle has an aperture 15 for engaging within a catch that is within the seatbelt buckle receiver 36 (see FIG. 3). The seatbelt buckle 12 is shaped and sized to fit within a slot 34 of the seatbelt buckle receiver 36.

Referring to FIG. 2, an elevational view of the window breaking mechanism 24 integrated into the seatbelt buckle 12 showing a seatbelt 20 threaded there through is shown. It is anticipated that the seatbelt 20 be configured in any way that seatbelts are integrated into vehicles. For example, one end of the seatbelt 20 is secured to a floor of the vehicle and opposing ends of the seatbelt 20 is connected to the vehicle, typically through a spring-loaded receiver at one-end for pulling in slack of the seatbelt 20 and locking the seatbelt 20 after detecting stopping force from the vehicle breaking or hitting another object/vehicle, etc.

Referring to FIG. 3, a perspective view of the window breaking mechanism 24 integrated into the seatbelt buckle 12 showing the window breaking mechanism 24 and seatbelt buckle 12 disengaged from the seatbelt buckle receiver 36 and being used to break a window 60 is shown. In this view, it is shown how the seatbelt 20 threads through the seatbelt aperture 14 of the seatbelt buckle 12. In operation, the seatbelt buckle 12 is disengaged from the seatbelt buckle receiver 36 by pressing a seatbelt release button 32 on the enclosure of the seatbelt buckle receiver enclosure 30. The seatbelt buckle receiver 36 is secured to the vehicle (not shown for clarity and brevity purposes), for example, by a second section of seatbelt material 40. Once the seatbelt buckle 12 is disengaged from the seatbelt buckle receiver 36, the window breaking mechanism 24 is pushed against the window 60, forcing the movable portion 16 to telescope into the housing 50 until the movable portion 16 moves far enough into the housing 50, at which time, the glass-breaking spike 56 is rapidly forced out of the aperture 18 towards the window 60, thereby causing the window 60 to crack and break.

By having a window breaking mechanism 24 integrated into the seatbelt buckle 12, the window breaking mechanism 24 is readily available and easily located after an accident or when otherwise needed. Although there is no requirement that all seatbelt buckles 12 within a vehicle have the window breaking mechanism 24 integrated therein, it is anticipated that many or every seatbelt buckle 12 within a vehicle have a window breaking mechanism 24 included, as the driver may not be capable of operating the window breaking mechanism 24 and, having multiple window breaking mechanisms 24, one with each seatbelt buckle 12, other occupants are able to individually break their associated windows 60 after an accident.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A window breaking system comprising:
a seatbelt buckle interfaced to a vehicle through a seatbelt;
a seatbelt buckle receiver for removably receiving the seatbelt buckle, the seatbelt buckle receiver is interfaced to the vehicle; and
a window breaking mechanism integrated to the seatbelt buckle.

2. The window breaking system of claim 1, wherein the window breaking mechanism is spring-loaded.

3. The window breaking system of claim 2, wherein the window breaking mechanism comprises a glass-breaking spike that, upon pushing the window breaker against the window, the glass-breaking spike is hurled against the window under force of a spring.

4. A method of exiting a vehicle comprising:
disengaging a seatbelt buckle from a seatbelt buckle receiver, the seatbelt buckle having an integrated window breaking mechanism;
pushing a movable portion of the integrated window breaking mechanism against a window until a glass-breaking spike of the integrated window breaker hurling at the window; and
exiting through an opening vacated by the window.

5. The method of claim 4, further comprising a step of removing the window that is now cracked and/or broken before the step of exiting through the opening vacated by the window.

6. The method of claim 4, wherein the integrated window breaking mechanism is spring-loaded.

7. The method of claim of claim 6, wherein the integrated window breaking mechanism comprises the glass-breaking spike that, upon pushing the window breaker against the window, the glass-breaking spike hurling against the window under force of a spring.

8. An apparatus for breaking a window comprising:
a seatbelt buckle; and
a window breaking mechanism integrated into the seatbelt buckle.

9. The apparatus for breaking the window of claim 8, wherein the window breaking mechanism is spring-loaded.

10. The apparatus for breaking the window of claim 9, wherein the window breaking mechanism comprises a glass-breaking spike that, upon pushing the window breaker against a window, the glass-breaking spike is hurled against the window under force of a spring.
